(19) United States
(12) Patent Application Publication
(10) Pub. No.: US 2009/0078690 A1
(43) Pub. Date: Mar. 26, 2009

(54) FIBER REINFORCED HEATING UNIT AND MATTRESS WITH THEREOF

(76) Inventors: Mi-Ae Lee, Gyeonggi-do (KR); Sang-Do Yeom, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 11/719,331

(22) PCT Filed: Nov. 10, 2005
(86) PCT No.: PCT/KR05/03809

§ 371 Date: May 15, 2007

(30) Foreign Application Priority Data
Nov. 16, 2004 (KR) 20-2004-0032405
Dec. 28, 2004 (KR) 10-2004-0113502

(51) Int. Cl. H05B 3/36; A47C 21/04; H05B 3/38

(52) U.S. Cl. 219/217; 219/545; 5/421

(57) ABSTRACT

Disclosed herein are a fiber-reinforced heating unit (100) and a mattress comprising the fiber-reinforced heating unit (100) installed therein. The heating unit (100) comprises flexible filaments (11) woven vertically and horizontally in a net, a stiff synthetic resin filament (12) alternately woven with the flexible filament (11) in either a vertical direction or a horizontal direction, and copper wires (32) woven together with the flexible filaments (11) on the longitudinal edges at both sides and the center and the woven material is dipped in liquid carbon, followed by drying. The copper wires (32) on the both longitudinal edges are connected to positive (+) terminal (31, 51) and the copper wires at the center are connected to a negative (−) terminal (41). The carbon-coated woven material has coating layers (90) formed by compression or impregnation with a gel type flexible synthetic resin at the top and the bottom. The heating unit (100) can maintain an original net structure by the stiff synthetic resin filament (12) while maintaining flexibility. The heating unit (100) has excellent durability since the flexible filament (11) is not disconnected even when heating unit is bent or folded. Also, the heating unit (100) can provide partial heating by selectively applying electricity to the positive (+) terminals (31, 51) at the both edges.

### TECHNICAL FIELD

The present invention relates to a mattress comprising a carbon-coated web type heating unit for generating heat by electrical resistance, in which the heating unit is readily prepared and has excellent durability such as prevention of disconnection of fiber filaments and can be partly heated by selection of a user.

### BACKGROUND ART

Conventionally, among heating units installed in a mattress or a mat, a large number of carbon-containing heating units are developed and widely used. For example, Korean Utility Model Registration Number 0231389 discloses a health mat, Korean Utility Model Registration Number 0278864 discloses a carbon woven heating mattress for a bed and Korean Utility Model Registration Number 258731 discloses an electric mattress for a bed.

These mattresses all comprise carbon filaments, that is, carbon-made threads, which are arranged at a predetermined interval or woven to generate heat by supplied electricity, though they have some differences in their constructions.

However, the carbon filament is made of mainly carbon and its production cost is thus very expensive. Also, when the heating unit formed by arranging or weaving the carbon filaments is folded, the carbon filament is easily disconnected and fails to generate heat, leading poor durability.

In order to solve such problems, Korean Utility Model Registration No. 0195313 discloses a heating mat using a planar heating unit, in which, instead of the carbon filament, carbon-coated cotton filament, prepared by impregnating cotton filament with a mixture of carbon and an adhesive, followed by drying, is connected to an electric source to serve as a heating wire and is coated with PVC for application.

However, when a woven material of carbon-coated cotton filaments is coated with PVC, it cannot maintain its original structure (roughly rectangular net structure).

Thus, for coating of the woven material, the filaments should be evenly spread over the woven material so that the filaments are not massed or folded in a part. Cotton filament is flexible and the operation for spreading the cotton filament is complicated and requires a long time. Also, when the PVC coating is performed while the cotton filaments are not evenly spread, there may be non-heating parts or there may be excessively heating parts where the cotton filaments are folded or densely massed. Accordingly, it is difficult to provide uniform temperature distribution.

### DISCLOSURE OF INVENTION

### Technical Problem

Accordingly, the present invention has been made to solve the above-mentioned problems occurring in the prior art, and it is an object of the present invention to maintain an original structure of a carbon-coated woven net, thereby facilitating coating provide carbon, to provide uniform temperature distribution over the whole mattress, to provide partial heating selectively over the whole area of the heating unit and to maintain flexibility after external coating or compression with a synthetic resin material, without deterioration in cushioning of the mattress.

It is another object of the present invention to provide selective partial heating by a user upon application of a carbon-heating unit to a mattress. That is, it is to realize partial heating in a selected section.

### Technical Solution

To accomplish the above objects of the present invention, according to the present invention, there is provided a heating unit comprising a net of flexible filament woven vertically and horizontally, in which the net includes stiff synthetic fiber alternately woven with the flexible fiber in either a vertical direction or a horizontal direction to maintain the original shape of the net.

Also, the heating unit according to the present invention further comprises electrode parts formed by weaving several strands of copper wires together with the flexible filament on the longitudinal edges at both sides and the center, the copper wires at the both sides being connected to positive (+) terminals and the central copper wires being connected to a negative (−) terminal, and a controller for selectively applying electric power to the positive (+) electrodes.

Also, the heating unit according to the present invention further comprises a carbon-coated woven material having a flexible gel type synthetic resin layer formed by compression or impregnation.

### ADVANTAGEOUS EFFECTS

As described above, according to the heating unit according to the present invention, since the woven material of flexible filaments includes stiff synthetic filament alternately woven with the flexible filament in either a vertical direction or a horizontal direction, it is possible to maintain the original space between the woven flexible filaments while preventing entanglement of flexible filaments, whereby the gel type synthetic resin coating (compression or impregnation) operation is readily performed. Also, it is possible to provide uniform temperature distribution over the entire area of the woven material. Further, since the heating unit has flexibility provided by the gel type synthetic resin coating, when installed in a mattress of a bed, it does not deteriorate cushioning of spring.

Also, since a pair of positive (+) electrode parts is provided at the longitudinal edges of the heating unit and a negative (+) electrode part is provided at the center, when a positive (+) electrode part is connected to an electric source by selection of a user, it is provide partial heating. Therefore, the heating unit can be selectively operated by two users and unnecessary electricity consumption can be prevented when one person uses the heating unit.

Further, when jade powder, yellow clay powder, ceramic powder and charcoal powder contained in a fiber cloth is added to the heating unit, a great amount of far-infrared rays or anions is emitted by the heat generated in the heating unit. In addition, magnet promotes blood circulation by magnetic force and the copper wires intercept the harmful electromagnetic wave generated in the heating unit.

### BRIEF DESCRIPTION OF THE DRAWINGS

Further objects and advantages of the invention can be more fully understood from the following detailed description taken in conjunction with the accompanying drawings in which:

FIG. 1 is a plane view of the heating unit according to an embodiment of the present invention;

FIG. 2 is a cross-sectional view cut off at A-A of FIG. 1;

FIG. 3 is a cross-sectional view cut off at B-B of FIG. 1;

FIG. 4 is a perspective view, partly broken away, to show the installation of the heating unit in a mattress according to an embodiment of the present invention; and

FIG. 5 is a cross-sectional view of a mattress having the heating unit installed according to an embodiment of the present invention.

### BEST MODE FOR CARRYING OUT THE INVENTION

Now, a preferred embodiment of the present invention will be described in detail with reference to the drawings.

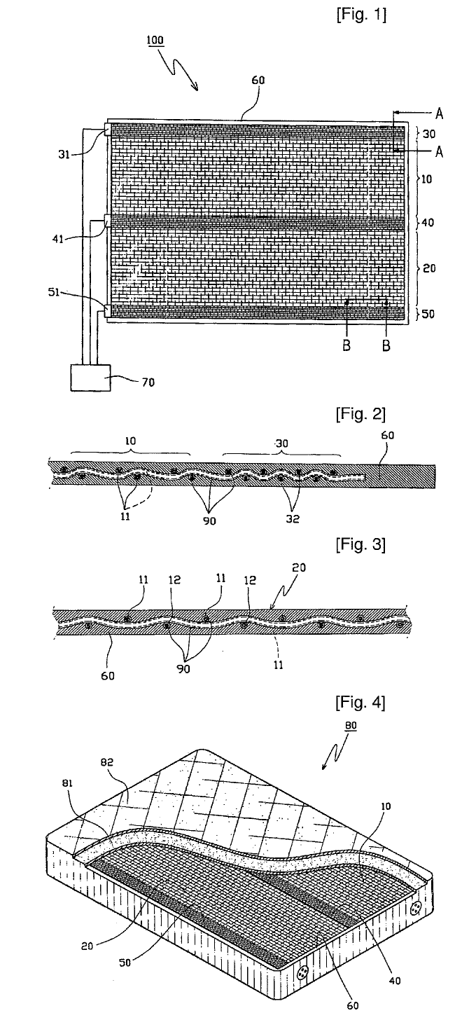

FIG. 1 is a plane view of the heating unit according to an embodiment of the present invention.

Referring to FIG. 1, the heating unit 100 according to the present invention includes a net woven vertically and horizontally with flexible filament to have a size suitable for installation in the whole area of a mattress, a pair of electrode parts 30, 50 formed by weaving several copper wires together with the flexible filament at the longitudinal edge (called ‘longitudinal edge’ hereinafter) and an electrode part 40 formed by weaving several copper wires together with the flexible filament at the center.

In a preferred embodiment, the pair of electrode parts 30, 50 are connected to positive (+) terminals 31, 41 and the electrode part 40 disposed at the center is connected to a negative (−) terminal 41 and the positive (+) terminals 31, 51 and the negative (−) terminal 41 are electrically connected to a controller 70.

The heating unit 100 comprises a first heating part 10 disposed between the electrode part 30 on the longitudinal edge at one side and the central electrode part 40, a second heating unit 20 disposed between the electrode part 50 at the other side and the central electrode part 40 and a flexible get type coating layer 60 on the whole area of the heating unit 100.

The heating unit 100 generates heat using conductive carbon and its carbon construction and weaving will be explained concretely referring to FIG. 2 and FIG. 3, below.

FIG. 2 is a cross-sectional view cut off at A-A of FIG. 1 and FIG. 3 is a cross-sectional view cut off at B-B of FIG. 1.

Referring to FIG. 1 and FIG. 2, partly showing the lateral cross-sectional construction of the electrode part 30 and the first heating part 10, the flexible filament 11 of the first heating part 10 is flexible and cross-woven vertically and horizontally in a lattice. The horizontal flexible filament is relatively densely woven with several strands of copper wires 32 at the electrode part 30. Other electrode parts 40, 50 (not shown) are constructed similarly. The weaving is performed according to common weaving operation.

Referring to FIG. 1 and FIG. 3 showing the vertical cross-sectional construction of the second heating part 20, the flexible filament 11 is cross-woven vertically and horizontally in a net. However, as shown in FIG. 3, the horizontal flexible filament 11 is woven alternately with a stiff synthetic resin filament 12.

That is, one vertical flexible filament is perpendicularly crossed with a flexible filament, a stiff synthetic resin filament, a flexible filament and a stiff synthetic resin filament in this order.

The stiff synthetic resin filament 12 is stiffer than the flexible filament and thus, the stiff synthetic resin filament 12 maintains the original woven structure by holding the space between the woven flexible filaments and preventing entanglement of flexible filaments. The woven net according to the present invention more readily returns to the original structure, as compared to the woven material of only flexible filaments.

The stiff synthetic resin filament having such functions is provided over the entire width of the heating unit in the longitudinal direction or is provided over the entire length of the heating unit in the horizontal direction.

Next, the woven material is impregnated with liquid conductive carbon, followed by drying, to for a carbon coating layer 90 all over the flexible filament 11, the stiff synthetic resin filament 12 and the copper wire 32.

Also, the woven material having the carbon coating layer 90 formed is thermally compressed with a flexible gel type synthetic resin, for example, a gel type urethane resin, a gel type PVC, a gel type PE, a gel type PET and the like and dried or impregnated with one of various gel type synthetic resins to form a flexible synthetic resin coating layer all over the woven material.

Here, the stiff synthetic resin filament 12 is readily unfolded for coating and compression during the process for forming the synthetic resin coating layer 60, since it can maintain the woven material in the original structure. Also, the mesh size formed in the web of the flexible filaments can be constantly maintained and thus, it is possible to maintain the temperature distribution evenly over the entire area of the woven material. Further, the woven heating unit is not disconnected even when the flexible synthetic resin coating layer 60 is bent or folded.

FIG. 4 is a perspective view, partly broken away, to show the installation of the heating unit in a mattress according to an embodiment of the present invention.

Referring to FIG. 1 and FIG. 4, the heating unit 100 according to the present invention comprises electrode parts 30, 50 at the longitudinal edges connected to positive (+) terminals 31, 51, a central electrode part 40 connected to a negative (−) terminal 41, and a controller 70 for controlling input of electric power to these terminals.

Therefore, when the negative (−) terminal 41 is continuously connected to an electric source and only one positive (+) terminal at any one side, for example the positive (+) terminal 31, is connected to an electric source, only the first heating part 10 generates heat while the second heating part 20 does not generate heat. On the contrary, when only the positive (+) terminal 51 is connected to an electric source, the second heating part 20 generates heat. Therefore, it is possible for a user to use partial heating by means of the controller 70.

Also, when the heating unit 100 is installed in a bed, a fiber cloth 81 is installed between a mattress cover 82 and the heating unit. The fiber cloth 81 may contain a material which can emit far-infrared rays beneficial to human bodies, for example, jade, yellow clay, ceramic and charcoal. Also, Magnet emitting magnetic force to help blood circulation may be mounted in several spots. Further, copper wire net may be mounted to intercept the harmful electromagnetic wave generated in the heating unit. In addition, tourmaline powder or silver powder emitting anions may be added.

It is known that silver, yellow clay and charcoal powder may prevent inhabitation of bacteria or mites. Tourmaline, also known as electric stone, emits micro-current itself which is increased by heating. Therefore, such added or combined materials can actively work by the heat generated in the heating unit 100.

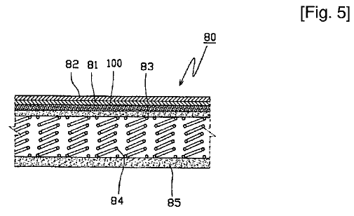

FIG. 5 is a cross-sectional view of a mattress having the heating unit installed according to an embodiment of the present invention.

Referring to FIG. 5, under the mattress cover 82, the fiber cloth 81, the carbon-heating unit 100, a latex pad 83, springs 84 and a memory foam pad 85 are sequentially laminated. However, the present invention is not limited to the shown lamination sequence. The above-listed components may be selected as needed, and their lamination sequence may vary.

The latex pad 83 is a cushion material made of fluid extracted from rubber tree and has excellent restitutive and tensile force and good air permeability since it is a porous material.

Also, the memory foam pad 85 is formed of a low resilience and high-density material and has excellent shock absorption. When this material is disposed under the mattress, vibration or impact generated on the mattress is not transferred to the lower part of the mattress.

So far, the preferred embodiment of the present invention is explained on the basis of the construction shown in FIG. 1 to FIG. 5. However, it is not to be restricted by the embodiments but only by the appended claims. It is to be appreciated that those skilled in the art can change or modify the embodiments without departing from the scope and spirit of the present invention.

1. A fiber-reinforced electrical heating unit comprising a net of flexible filament woven vertically and horizontally and a carbon coating layer formed thereon by impregnation or spray of liquid carbon, in which the net of flexible filament includes stiff synthetic fiber alternately woven with the flexible filament in either a vertical direction or a horizontal direction.

2. The heating unit according to claim 1, which further comprises a pair of electrode parts formed by weaving a several strands of copper wires together with the flexible filament at both sides, the electrode parts being connected to a positive (+) terminal and a negative (−) terminal, respectively.

3. A fiber-reinforced electrical heating unit comprising a net of flexible filament woven vertically and horizontally and a carbon coating layer formed thereon by impregnation or spray of liquid carbon, in which electrode parts are formed by weaving several strands of copper wires together with the flexible filament on the longitudinal edges at both sides and the center, a pair of the electrode parts on the longitudinal edges being connected to positive (+) terminals and the central electrode part being connected to a negative (−) terminal, and a controller is provided to selectively apply electric power to the pair of positive (+) terminals.

4. The heating unit according to any one of claim 1 to 3, in which a coating layer of a gel type synthetic resin is formed on the surface of the heating unit.

5. The heating unit according to claim 4, in which the gel type synthetic resin is selected from urethane, PVC, PE and PET and the coating of the gel type synthetic resin is performed by compression and drying or by impregnation and drying.

6. A mattress comprising a fiber cloth containing at least one selected jade powder, silver powder, yellow clay powder, ceramic powder, charcoal powder, magnet or copper wires in a net form, in which the fiber cloth is connected to a fiber-reinforced heating unit defined in claim 1 or 2 to be indirectly heated.

7. The mattress according to claim 6, in which a spring layer is disposed under the fiber-reinforced heating unit and one selected from a latex pad and memory foam pad or a combination thereof is disposed over/under the spring layer.

8. The mattress according to claim 6, in which one selected from a latex pad and memory foam pad or a combination thereof is disposed under the fiber-reinforced heating unit.
